(19) United States
(12) Patent Application Publication
(10) Pub. No.: US 2025/0182023 A1
(43) Pub. Date: Jun. 5, 2025

(54) DISTRIBUTED COMPUTER SYSTEM FOR MANAGEMENT OF SERVICE REQUEST AND METHOD OF OPERATION THEREOF

(71) Applicant: UVUE LTD., Bury St Edmunds (GB)

(72) Inventors: Humayun Munir Sheikh, Bury St Edmunds (GB); Toby William Simpson, Bury St Edmunds (GB)

(21) Appl. No.: 19/049,081

(22) Filed: Feb. 10, 2025

Related U.S. Application Data
(63) Continuation of application No. 17/234,932, filed on Apr. 20, 2021.

(51) Int. Cl. G06Q 10/0631

(52) U.S. Cl. CPC G06Q 10/06316

(57) ABSTRACT

Disclosed is a distributed computer system that comprises worker nodes, wherein the plurality of worker nodes are worker nodes for fulfilling a service request, the system further comprising a distributed ledger arrangement for aggregating information relating to the service request from the plurality of worker nodes, wherein the system is configured to execute at least one smart contract using the distributed ledger arrangement for aggregation; at least one secondary distributed ledger for coordinating aggregation of information relating to the service request from the plurality of worker nodes that are configured to fulfill at least a part of the service request and provide corresponding information to the distributed computer system for aggregation via the distributed ledger arrangement

### CROSS-REFERENCE TO RELATED APPLICATIONS

This application is a continuation of U.S. patent application Ser. No. 17/234,932 filed on Apr. 20, 2021, which had incorporated by reference therein, in its entirety, U.S. patent application Ser. No. 16/130,218, filed on Sep. 13, 2018.

### TECHNICAL FIELD

The present disclosure relates generally to systems for managing information related to a service request using a blockchain; and more specifically, to distributed computer systems for managing information relating to service request.

### BACKGROUND

Recently, modem technology has enabled human life to be increasingly faster in pace, and in certain aspects, simpler. Conventionally, when a given user wants to procure services, such as for example day-to-day activities like cleaning, cooking and communicating, a significant amount of time and effort have to be invested. Typically, service providers may be used to procure services to perform such activities. Furthermore, the user may hire services of an intermediary. Herein, the intermediary may assist the user in selecting the service provider. Additionally, in a case of an unsuccessful service provided by the service provider, the user may incur loss of payment given to the intermediary and the hired service provider.

Smart contracts are used to automatically execute, control or document legally relevant services according to the terms of a contract or an agreement. However, an unsuccessful service may influence the outcome of the smart contact that depends on oracle. Herein, oracles are pieces of deployed software that map data that is collected from the outside world to state variables recorded on a distributed ledger. However, there are two single points of failure. Firstly, the oracle to distributed ledger transfer could be compromised. Herein, the server hosting the oracle may crash thereby halting updates, or the private keys of the trusted party may be stolen by an attacker. Secondly, API to oracle transfer may become faulty or malicious. For example, a data feed API supplying the oracle may become compromised or unavailable.

A major drawback from an economic perspective is that the payment given to the computing node is likely to be significantly smaller than the pay-off from executing an attack. Furthermore, it may be possible for the oracle provider to use prior knowledge of the data feed to obtain an advantage over other users of the smart contract. Similar drawbacks encountered in conventional finance are overcome by providers of financial information. Furthermore, the providers of the financial information are required to have a public identity and be subject to regulations and law enforcement. Additionally, analogous approaches may be applied in the context of distributed ledgers by enabling competition between different computing nodes with public identities, and by staking or reputation systems. Moreover, all of the systems mentioned in the present disclosure may improve security by strongly incentivizing good service provision compared with attacks.

Therefore, in light of the foregoing technical problems, there exists a need to overcome the aforementioned problems associated with providing services to users.

### SUMMARY

The present disclosure seeks to provide a distributed computer system that comprises a plurality of worker nodes that are autonomous economic agents. The present disclosure also seeks to provide a method of operating a distributed computer system that comprises a plurality of worker nodes that are autonomous economic agents. An aim of the present disclosure is to provide a solution that overcomes at least partially the problems encountered in prior art.

In one aspect, there is provided a distributed computer system that comprises a plurality of worker nodes that are coupled together via a data communication network to exchange data therebetween, wherein the worker nodes include computing arrangements and local databases to process and store data therein, wherein the plurality of worker nodes are autonomous economic agents (AEAs), wherein the distributed computer system is configured to use the plurality of worker nodes for fulfilling a service request, the system further comprising
a distributed ledger arrangement for aggregating information relating to the service request from the plurality of worker nodes, wherein the system is configured to execute at least one smart contract using the distributed ledger arrangement for aggregation; and
at least one secondary distributed ledger for coordinating aggregation of information relating to the service request from the plurality of worker nodes that are configured to fulfill at least a part of the service request and provide corresponding information to the distributed computer system for aggregation via the distributed ledger arrangement.

Optionally, the system further comprises a data processing arrangement for executing at least one smart contract using the distributed ledger arrangement for aggregation.

Optionally, the plurality of worker nodes are configured to execute supplementary tasks relating to the service request.

Optionally, the plurality of worker nodes are communicably interconnected using the distributed computer system for collective execution of the service request.

Optionally, the service request includes at least one of: a time needed for providing the service; a price associated with the service; a quality associated with the service; at least one preference associated with the service.

In another aspect, the present disclosure further provides a method for operating a distributed computer system that comprises a plurality of worker nodes that are coupled together via a data communication network to exchange data therebetween, wherein the worker nodes include computing arrangements and local databases to process and store data therein, wherein the plurality of worker nodes are autonomous economic agents (AEAs), wherein the distributed computer system is configured to use the plurality of worker nodes for fulfilling a service request, wherein the method comprises:
providing the distributed computer system with a distributed ledger arrangement for aggregating information relating to the service request from the plurality of worker nodes, wherein the system is configured to execute at least one smart contract using the distributed ledger arrangement for aggregation; and
using at least one secondary distributed ledger for coordinating aggregation of information relating to the service request from the plurality of worker nodes that are configured to fulfill at least a part of the service request and provide corresponding information to the distributed computer system for aggregation via the distributed ledger arrangement.

Optionally, the method further comprises providing the distributed computer system with a data processing arrangement for executing at least one smart contract using the distributed ledger arrangement for aggregation.

Optionally, the plurality of worker nodes are configured to execute supplementary tasks relating to the service request.

Optionally, the method comprises the communicably interconnecting the plurality of worker nodes using the distributed computer system for collective execution of the service request.

Optionally, the service request includes at least one of: a time needed for providing the service; a price associated with the service; a quality associated with the service; at least one preference associated with the service.

Embodiments of the present disclosure substantially eliminate or at least partially address the aforementioned problems in the prior art, and enable aggregation of information relating to a service request in a manner that is efficient, less resource intensive and not prone to attacks from malicious entities.

Additional aspects, advantages, features and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

Embodiments of the present disclosure will now be described, by way of example only, with reference to the following diagrams wherein:

FIG. 1 is a block diagram illustrating a simple architecture diagram for an on-chain oracle, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, the present disclosure provides a distributed computer system that comprises a plurality of worker nodes that are coupled together via a data communication network to exchange data therebetween, wherein the worker nodes include computing arrangements and local databases to process and store data therein, wherein the plurality of worker nodes are autonomous economic agents (AEAs), wherein the distributed computer system is configured to use the plurality of worker nodes for fulfilling a service request, the system further comprising:
a distributed ledger arrangement for aggregating information relating to the service request from the plurality of worker nodes, wherein the system is configured to execute at least one smart contract using the distributed ledger arrangement for aggregation;
at least one secondary distributed ledger for coordinating aggregation of information relating to the service request from the plurality of worker nodes that are configured to fulfill at least a part of the service request and provide corresponding information to the distributed computer system for aggregation via the distributed ledger arrangement.

In another aspect, the present disclosure provides a method for operating a distributed computer system that comprises a plurality of worker nodes that are coupled together via a data communication network to exchange data therebetween, wherein the worker nodes include computing arrangements and local databases to process and store data therein, wherein the plurality of worker nodes are autonomous economic agents (AEAs), wherein the distributed computer system is configured to use the plurality of worker nodes for fulfilling a service request, wherein the method comprises
providing the distributed computer system with a distributed ledger arrangement for aggregating information relating to the service request from the plurality of worker nodes, wherein the system is configured to execute at least one smart contract using the distributed ledger arrangement for aggregation;
using at least one secondary distributed ledger for coordinating aggregation of information relating to the service request from the plurality of worker nodes that are configured to fulfill at least a part of the service request and provide corresponding information to the distributed computer system for aggregation via the distributed ledger arrangement.

The worker nodes include computing arrangements that are operable to respond to, and processes instructions and data therein. The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the system.

The computing arrangements are processing devices that operate automatically. In such regard, the computing arrangements may be equipped with artificial intelligence algorithms that are configured to respond to and to perform the instructions that drive the system based on data learning techniques. The computing arrangements devices capable of automatically responding and of performing instructions based on input provided from one or more users (namely, the worker nodes participating in the system). The worker nodes further include local databases to store data therein. Furthermore, the collective learning of the worker nodes is managed within the distributed computer system. Notably, the computing model is trained between the plurality of worker nodes in a manner that the intermediary computing models that have been partially trained are shared between the worker nodes and resources of worker nodes are utilized productively.

Moreover, the plurality of worker nodes are communicably coupled to each other via the data communication network. The data communication network allows for communication among the plurality of worker nodes. In other words, each of the plurality of worker nodes is capable of communicating with other worker nodes via the data communication network in order to facilitate training of the computing model. Notably, the data communication network refers to an arrangement of interconnected, programmable and/or non-programmable components that, when in operation, facilitate data communication between one or more electronic devices and/or databases. Furthermore, the data communication network may include, but is not limited to, a peer-to-peer (P2P) network, a hybrid peer-to-peer network, local area networks (LANs), radio access networks (RANs), metropolitan area networks (MANs), wide area networks (WANs), all of or a portion of a public network such as global computer network known as the InternetB, a private network, a cellular network and any other communication system. Additionally, the data communication network employs wired or wireless communication that can be carried out via one or more known protocols.

The operation of the distributed computer system is coordinated by employing the distributed ledger arrangement. Herein, the term “distributed ledger arrangement” refers to a ledger (such as a database) comprising entries recording operations and/or contracts (preferably smart contracts), with a timestamp. According to the common knowledge in the field of computer science and distributed ledgers, smart contracts may be one or more computer algorithms or a transaction protocols, where these may be executed via computer programs, respectively intended to automatically execute events or actions according to agreed terms (the contract terms). Smart contracts may also control, record or document such events or actions according to the terms agreed, for example agreed on a contract.

Pursuant to embodiments of the present disclosure, the distributed ledger arrangement refers to a database of the entries or blocks. Moreover, the distributed ledger arrangement is consensually shared and synchronised in a decentralised form across the plurality of worker nodes. In this regard, the ledger is consensually shared and synchronised across multiple sites, institutions or geographies. Such worker nodes can be established across different locations. More than one worker node may be present within a device such as computer. Beneficially, the distributed ledger arrangement eliminates the need of a central authority to maintain the distributed ledger arrangement and protect it against manipulation. Specifically, the entries or blocks in the distributed ledger arrangement are monitored publicly, thereby making the distributed ledger arrangement robust against attacks. Notably, the worker nodes may be independent entities that may become a part of the distributed computer system and provide resources thereof in exchange for a reward provided as a compensation for the resources used for training the computing model.

The distributed ledger arrangement is a database that is replicated across many computers and/or geographical locations. The worker nodes that maintain this shared database converge on a consensus state without requiring any centralized authority. Most modem ledger implementations maintain two data structures; the first is an ordered list of transactions while the second is a state database, which maintains records of state variables that are derived from the transaction set. At their simplest, this state database can represent credits associated with user accounts, which are modified over time by the time-ordered append-only record of transactions.

The first component is the ledger itself and could be implemented using a blockchain, a transaction chain, a DAG, a Tangle or any other method from which absolute or partial temporal ordering can be established. The second component could be a key-value store, a Git repository, an ordinary database, file system, memory or any other media capable of storing data. There are many different blockchain implementations, including Bitcoin, Litecoin, Dogecoin, BigchainDB, Hyperledger Fabric, Hyperledger Sawtooth Lake, Ethereum, Neo and numerous others.

It will be appreciated that the plurality of worker nodes (namely, peers) in the distributed ledger arrangement may access each of the entries in the distributed ledger arrangement and may own an identical copy of each of the entries. Notably, an alteration made to the distributed ledger arrangement is reflected almost instantly to each of the plurality of worker nodes. Subsequently, an addition of an entry is completed when all or some of the plurality of worker nodes perform a validation with respect to the addition. In such case, the entry is recorded (namely, added) in the distributed ledger arrangement in an immutable form when at least a threshold number of worker nodes from the plurality of worker nodes reach a consensus that the entry is valid. Alternatively, recording of the entry or the block is denied when the threshold number of worker nodes reach a consensus that the entry is invalid. In an example, the threshold number of worker nodes to reach a consensus may be more than fifty percent of the plurality of worker nodes. Optionally, information in the distributed ledger arrangement is stored securely using cryptography techniques.

The distributed ledger arrangement is arranged to execute at least one smart contract via use of the distributed ledger arrangement. Herein, the term “smart contract” refers to a computer protocol implemented using the distributed ledger arrangement comprising information required to coordinate the collective learning of the worker nodes by the distributed computer system. Moreover, the smart contract permits trusted execution thereof without involving a central authority, legal system, or externally enforced mechanisms. Pursuant to the embodiments of the present disclosure, the smart contract is employed to coordinate learning between the worker nodes and to ensure that the learning parameters relating to training of the computing model are provided to the plurality of worker nodes.

Optionally, the distributed computer system further comprises a data processing arrangement for executing at least one smart contract using the distributed ledger arrangement for aggregation. Notably, the data processing arrangement is communicably coupled to the plurality of worker nodes in the distributed computer system. Herein, the data processing arrangement is operable to (namely configured to) track operation of each of the worker nodes. Furthermore, the data processing arrangement may include, but is not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the data processing arrangement can be one or more individual processors, processing devices and various elements associated with a processing device that may be shared by other processing devices.

The plurality of worker nodes are autonomous economic agents (AEAs). The term “autonomous economic agents” (referred to herein later as “AEAs”) as used herein, relates to software modules that are configured to execute one or more tasks. Such tasks may include communication of the AEAs with each other, processing of information and so forth. In an example, the AEAs are configured to employ artificial intelligence (AI) algorithms and machine learning for execution of the one or more tasks. In another example, the AEAs are associated with a digital environment (referred to herein later as “Open Economic Framework” or “OEF”). The OEF is a computing framework that enables execution of tasks associated with various AEAs within the OEF. Furthermore, the OEF is configured to provide various tools, security protocols, rules and suchlike for the execution of tasks including, but not limited to, communication, processing of information and so forth, between different AEAs associated with the OEF. For example, the OEF is configured to allow access to one or more AEAs to operate within the OEF based on a set of rules and/or security protocols. Similarly, the OEF may deny access to one or more AEAs to operate within the OEF upon determining that the AEAs do not comply with the set of rules and/or security protocols. In one example, the OEF is implemented by one or more AEAs that are configured to enable communication between other AEAs within the OEF, process information associated with interaction between other AEAs within the OEF, provide (or deny) access to one or more AEAs to the OEF and so forth. Moreover, the OEF enables to provide a decentralized economic market for enabling various services to be provided and/or procured by the AEAs. Such a decentralized economic market may be representative of a real-world environment, such as a real-world market where one or more services are provided and/or procured.

In an embodiment, the service request includes at least one of a time needed for providing the service, a price associated with the service, a quality associated with the service, and/or at least one preference associated with the service. For example, the user specifies a parameter (such as, using the graphical user interface associated with a client device) including at least one of the time, the price, the quality and/or at least one preference that is required by the user in the provided service.

In such an instance, the parameter is provided to the client AEA with the generated service request. Furthermore, the client AEA is configured, namely operable, to use the parameter to provide the maximum value to the user. In one example, the service request includes the price associated with the service, such as a minimum and maximum price associated with the service. In such instance, the client AEA enables the user to obtain the service at a price within the minimum and maximum prices specified by the user. Preferably, the client AEA enables the user to obtain the service associated with the minimum price, thereby, enabling maximum value to be provided to the user. In another example, the service request includes a preference associated with the service, such as, to obtain an eco-friendly service. In such an instance, the client AEA enables the user to obtain the service from a service provider that utilizes eco-friendly sources of energy (and/or materials) for providing the service.

Herein, oracles are pieces of deployed software that map data that comes from the outside world to state variables recorded on blockchain, such as worker nodes map data that comes from the outside world to state variables recorded on the distributed ledger arrangement. Herein, the “world” could be a price feed from, for example, a commodities exchange while the “oracle” is a piece of software that consumes data from this API and updates the value stored in the smart contract by sending a transaction to the blockchain. Other smart contracts that use this feed pay for the oracle service by transferring the tokens when the oracle is read.

Notably, in the context of distributed ledger arrangement, there are several approaches that can be used to overcome fragility of the conventional protocols. In general, these involve aggregating information from multiple independent sources, such as the plurality of worker nodes. Most attempts to deal with this issue are applied at the Oracle-to-Blockchain level as it also corrects for upstream errors in the World-to-Oracle interface. The major advantage of the agent framework is that it can be used to flexibly solve much more complex and general World-to-Oracle problems than existing solutions.

The architectures that have been proposed to tackle problems in the conventional protocols can broadly be categorized into the middleware and blockchain solution. The advantages and disadvantages of these different approaches along with competitive advantage provided by the present disclosure in these domains are described below.

The primary approach refers to outputs being aggregated from several different oracles at the contract level. This approach has the several advantages, such as it is straightforward to add additional oracles and this process is linearly scalable, and it is possible to integrate staking and other incentives into the aggregation mechanism to improve security. Furthermore, the identity of oracle providers (namely, worker nodes) can be used to keep track of reputation.

Beneficially, the present disclosure provides several potential competitive advantages such as aggregation of oracles can be performed off-chain using agent-to-agent communication protocols. Furthermore, current technologies are very focused on public APIs with scripts continually polling information from a single source. This is fine but fragile as an autonomous agent can be programmed with more general behavior that enables it to deal with an API failing. Additionally, the present disclosure provides very fast aggregated signatures and threshold cryptography that can be used by the agents to reach agreement quickly and cheaply.

The secondary approach employed in the present disclosure is use of a dedicated side-chain, such as the at least one secondary distributed ledger to keep track of the aggregation step. This enables all of the aggregation logic to be implemented on a chain that is specialized for this purpose. Notably, the Cosmos-SDK with a Peggy-Ethereum bridge may be used to supply oracles to the Ethereum network. Beneficially, herein, aggregation is performed outside Ethereum, namely the distributed ledger arrangement, thereby lowering cost. Furthermore, a record of the behavior of different oracle service providers, namely the worker nodes, is maintained on a separate chain. Additionally, cross-chain bridge has higher security than a single oracle link, although the values themselves have similar security levels.

Beneficially, the present disclosure provides several potential competitive advantages such as DRB is an MPC unbiasable source of randomness, which is far superior to either the VRFs used by conventional randomness generators. Furthermore, aggregated signatures of the present disclosure should make chain syncing extremely fast compared with vanilla Cosmos-SDK, thereby increasing speed. This is a critical feature of any blockchain solution and a significant advantage over conventional protocols. Furthermore, the agent framework can be used to aggregate transactions and submit these to the chain so all the advantages of the “middleware” approach also apply. Additionally, Minimal Agency Consensus, when it becomes available, can be used to give priority to oracle transactions over other transaction types and ensure fairness and unbiasedness.

Optionally, the plurality of worker nodes are communicably interconnected using the distributed computer system for collective execution of the service request. Notably, the generalized oracle networks as described in the present disclosure can go well beyond simply transporting information from one-or-more APIs to a single blockchain; they instead can be seen as a generalized framework for aggregating information about the world.

The technical approach that the present disclosure employs are multi-agent systems, which are modular and extensible, and can therefore be used to deal with any complex or spatially distributed scenario or that involves multiple stakeholders. The agent framework extends this concept still further by making the agents themselves modular so that their behaviors (skills), communication with each other (protocols) and their relationship with external data sources (connections) can be combined together in different ways to create new functionality. The modularity enables re-use of existing elements to further accelerate the development process.

Optionally, the plurality of worker nodes are configured to execute supplementary tasks relating to the service request. Notably, a feature that distinguishes agents is that they can act in the outside world rather than simply react in the way that current oracle protocols do. This means the oracle itself can perform actions that support or supplement its role as an information provider. It could, for example, act as an arbitrage bot ensuring that prices in different liquidity pools are kept in sync with the current market price and thereby ensuring that (a) purchasers of tokens get the correct price for their exchanges and (b) liquidity providers maximize their returns. It is also possible that the agent can actively search for information in the world rather than passively routing information from an API.

Notably, multi-agent price settlement protocols can be applied to many different types of economic situations (hospitality, mobility, supply-chains) but the one that is best established is for peer-to-peer energy trading. In these markets, prosumers (who consume power but also have the capacity to generate it through batteries, solar, wind etc.) must determine a clearing price for the energy at a particular point in time. It is possible to show that this can be framed as a coalitional game theory problem and that convergence to a unique, global clearing price can be implemented using our agent framework. It is possible to also incentivize the agents to submit this clearing price to the blockchain, where it can be used by centralized energy grid operators for controlling their output.

Optionally, the present disclosure may further enable operators of smart devices to monetize the sale of their data. Two major barriers to this being possible arise from the difficulty of bootstrapping data marketplaces and secondly in data provenance and the problem of ensuring that the data provider is honest. These issues can be overcome by creating markets for many data providers to contribute to the submission of a global, aggregated value to an oracle. An example of this might, for example, be crop yields in a particular region. A farmer has an interest in knowing what the yield is likely to be in his farm, and may also wish to make this information available to other parties such as insurers. This information is also potentially of value to other farmers, and many other stakeholders who have an interest in food prices. It may be possible to design a market that incentivizes contributions of this type, and that is secure against lazy or malicious data submissions.

The present disclosure aims to build a decentralized random oracle from DRB and supply the DRB as an oracle for Ethereum and other Cosmos chains. Furthermore, the present disclosure aims to enable validators to serve as providers of VRFs (oracles) to other chains; and build multi- and aggregated-signature schemes to enable rapid syncing of light clients (agents) with the chain.

Furthermore, with respect to the agent framework, the present disclosure aims to build connection and skill modules along with smart contracts that enable a single agent to serve as an oracle (in progress); build a protocol that enables a collection of agents to reach agreement on a shared oracle value before submitting it to the chain; build a skill that is “reactive” i.e., responds to unavailability of an API, and build a connection module that enables agents to act as a light client.

### DETAILED DESCRIPTION OF THE DRAWINGS

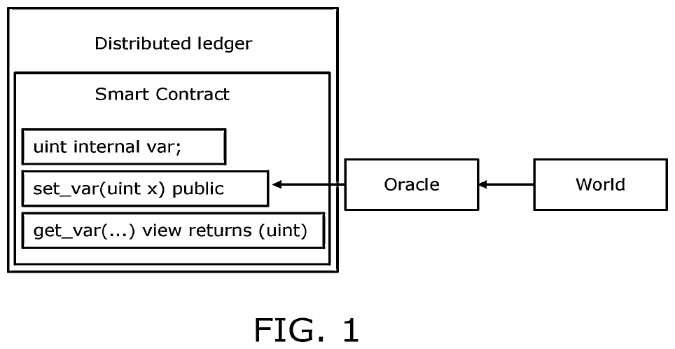

Referring to FIG. 1, there is shown a block diagram illustrating a simple architecture diagram for an on-chain oracle, in accordance with an embodiment of the present disclosure. Notably, the set var( ) function is used to modify the oracle variable var. The get var( ) function can be called by a user (typically another smart contract) to return the current oracle value. The call to get var( ) typically requires a token transfer, which provides the reward for the oracle/smart contract provider.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for operating a drone, comprising a decentralized computing network that comprises one or more autonomous economic agents, wherein each of the one or more autonomous economic agents is a software module connected to a data processing arrangement, wherein the system comprises:
a client autonomous economic agent, wherein the client autonomous economic agent is configured to, autonomously, generate and broadcast a service request to other autonomous economic agents; and
a plurality of service provider autonomous economic agents, each of the plurality of service provider autonomous economic agents being associated with one or more service components, wherein each of the one or more service components includes the drone and at least one of: a drone frame, a camera module, a sensor module, a mission planning module, a communication module, wherein each of the plurality of service provider autonomous economic agents is configured to:
receive the service request from the client autonomous economic agent;
in response to the service request, generate a service bid; and
communicate the service bid to the client autonomous economic agent,
wherein at least one service component from the one or more service components is associated with the drone, and
wherein the at least one service component is configured to autonomously provide the service requested.

2. A system of claim 1, wherein the data processing arrangement connected to the client autonomous economic agent is provided on a portable communication device.

3. A system of claim 1, wherein each of the plurality of service provider autonomous economic agents is connected to individual data processing arrangement that is further coupled to the one or more service components.

4. A system of claim 3, wherein each of the plurality of service provider autonomous economic agents are configured to collaboratively generate the service bid.

5. A system of claim 1, wherein the service request includes a request to perform aerial photography associated with a location, such as, for aerial inspection.

6. A system of claim 5, wherein the drone frame, the camera module, the sensor module, the mission planning module, and the communication module are components of the drone, wherein each of the plurality of service provider autonomous economic agents is configured to generate respective service requests and accept service bids generated by respective service provider autonomous economic agents.

7. A system of claim 1, wherein each of the plurality of service provider autonomous economic agents is configured to allow a revision of one or more characteristics associated with the service request.

8. A system of claim 1, wherein the service request further includes at least one of: a price associated with the service, a time associated with the service.

9. A system of claim 1, wherein the at least one service component employs at least one artificial intelligence algorithm, when in operation.

10. A system of claim 1, further comprising an open economic framework implemented on the decentralized computing network, wherein the open economic framework comprises a distributed ledger arrangement configured to store a confidence score associated with each autonomous economic agent, and to select a given service provider autonomous economic agent associated with a comparatively higher confidence score to provide the service.

11. A system of claim 10, wherein the distributed ledger arrangement is configured to employ a blockchain data structure.

12. A system of claim 10, wherein the open economic framework is operable to employ zero-knowledge protocol to compare the confidence scores associated with each of the plurality of service provider autonomous economic agents.

13. A system of claim 10, wherein the open economic framework is operable to obtain verifiable information associated with characteristics of the confidence score for each of the plurality of service provider autonomous economic agents, without disclosing identifiable information of the one or more other service provider autonomous economic agents thereto.

14. A system of claim 10, wherein when the camera module is a first service provider autonomous economic agent, the open economic framework is operable to:
perform artificial intelligence AI-driven negotiations between the first service provider autonomous economic agent with the drone frame to carry the camera module to a given location, wherein the drone frame is a second service provider autonomous economic agent;
perform AI-driven negotiations between the second service provider autonomous economic agent with a mission planning module for generating a flight plan for journey of the drone from a current location to the given location, wherein the mission planning module is a third service provider autonomous economic agent; and
execute at least one term via a smart contract deployed on the distributed ledger arrangement,
wherein for each of the plurality of service providers that are autonomous economic agents, at least one computing node is configured to:
generate respective service requests by the first service provider autonomous economic agent, and the second service provider autonomous economic agent;
generate service bids corresponding to the service requests;
employ a mechanism for the AI-driven negotiations to facilitate acceptance of the service bids; and
execute communication of the service bid to the client autonomous economic agent, via the smart contract.

15. A system of claim 10, wherein when the at least one service component further comprises an insurance module, the open economic framework is further configured to:
perform artificial intelligence AI-driven negotiations between the third service provider autonomous economic agent and an insurance provider to obtain an insurance for flight of the drone, wherein the insurance provider is a fourth service provider autonomous economic agent, and
execute at least one term via a smart contract deployed on the distributed ledger arrangement,
wherein for each of the plurality of service provider autonomous economic agents, the at least one computing node is further configured to:
generate another service request by the third service provider autonomous economic agent;
generate another service bid corresponding to the another service request;
employ mechanisms for the AI-driven negotiations to accept the another service bid; and
execute communication of said another service bid to the client autonomous economic agent, via the smart contract.

16. A system of claim 10, wherein for a given service provider autonomous economic agent, the at least one computing node is further configured to:
allow revision of one or more characteristics associated with the generated service request, using artificial intelligence AI-driven decision making, to revise the service request;
execute the revised service request via a smart contract deployed on the distributed ledger arrangement;
provide a portion of remuneration to a given service component, based on the revised service request, wherein a transaction related to the portion of the remuneration is executed via the smart contract;
employ at least one AI-driven mechanism to revise a flight plan of the drone in response to the revised service request;
determine whether the revised flight plan of the drone complies with one or more parameters provided with the service request; and
when it is determined that the revised flight plan of the drone complies with the one or more parameters provided with the service request, accommodate the revised service request into the flight plan, via the smart contract.

17. A method for operating a drone that is implemented using a system comprising a decentralized computing network that comprises one or more autonomous economic agents, wherein each of the one or more autonomous economic agents is a software module connected to a data processing arrangement, wherein the method comprises:
(i) autonomously, generating and broadcasting a service request, from a client autonomous economic agent to other autonomous economic agents;
(ii) using a plurality of service provider autonomous economic agents, each of the plurality of service provider autonomous economic agents being associated with one or more service components, wherein each of the one or more service components includes the drone and at least one of: a drone frame, a camera module, a sensor module, a mission planning module, a communication module,
wherein for each of the plurality of service providers, the method comprises:
receiving the service request from the client autonomous economic agent;
in response to the service request, generating a service bid; and
communicating the service bid to the client autonomous economic agent;
wherein at least one service component from the one or more service components is associated with the drone, and
wherein the at least one service component autonomously provides the service requested.

18. A method of claim 17, the drone frame, the camera module, the sensor module, the mission planning module, and the communication module being components of the drone, wherein the method further comprises generating respective service requests and accepting service bids generated by respective service provider autonomous economic agents.

19. A method of claim 17, further comprising allowing a revision of one or more characteristics associated with the service request.

20. A method of claim 17, further comprising storing a confidence score associated with each autonomous economic agent, at an open economic framework implemented on the decentralized computing network, wherein the open economic framework comprises a distributed ledger arrangement, and selecting a given service provider autonomous economic agent associated with a comparatively higher confidence score to provide the service.
